(19) United States
(12) Patent Application Publication
(10) Pub. No.: US 2024/0240673 A1
(43) Pub. Date: Jul. 18, 2024

(54) TORQUE-LIMITING COUPLING

(71) Applicant: Voith Patent GmbH, Heidenheim (DE)

(72) Inventors: Jochen Thielen, Nürnberg (DE); David Bergström, Hudiksvall (SE); Andreas Albinsson, Delsbo (SE)

(21) Appl. No.: 18/621,760

(22) Filed: Mar. 29, 2024

Related U.S. Application Data
(63) Continuation of application No. PCT/EP2022/069080, filed on Jul. 8, 2022.

(30) Foreign Application Priority Data
Sep. 29, 2021 (EP) 21199694.7

(51) Int. Cl. F16D 1/08; F16D 7/02; F16D 9/06

(52) U.S. Cl. CPC F16D 1/0805; F16D 7/021; F16D 9/06

(57) ABSTRACT

A torque limiting coupling has a shaft, a shear plate fixedly connected to the shaft, and a coaxially disposed coupling ring. The coupling ring has a lateral surface in contact with the shaft and a double-walled section with an internal annular pressure fluid chamber. When the fluid chamber is filled with pressurized fluid, the radial thickness increases and increases the pressure and friction forces for a torque transfer between the coupling ring and the shaft. A shear tube closes the pressurized fluid chamber. A shear plate is configured to cut off a tip of the shear tube in order to open the pressure fluid chamber when the first shaft slips relative to the coupling ring. A central bolt affixes the shear plate to the shaft by pressing a conical bushing of the shear plate onto a conical connector of the shaft.

### CROSS-REFERENCE TO RELATED APPLICATION

This application is a continuation, under 35 U.S.C. § 120, of copending International Patent Application PCT/EP2022/069080, filed Jul. 8, 2022, which designated the United States; this application also claims the priority, under 35 U.S.C. § 119, of European Patent Application EP21199694.7, filed Sep. 29, 2021; the prior applications are herewith incorporated by reference in their entirety.

### FIELD AND BACKGROUND OF THE INVENTION

The present invention relates to a torque limiting coupling comprising a first shaft, a shear plate fixedly connected with the first shaft and a coupling ring arranged coaxially to the first shaft. The coupling ring has a lateral surface which is in contact with a lateral surface of the first shaft. The coupling ring has a double-walled section with an internal annular pressure fluid chamber, designed in such a way, that this section increases its radial thickness when the fluid chamber is filled with pressurized fluid and thereby increases the pressure forces and the friction forces between the lateral surfaces of the coupling ring and the first shaft in order to allow torque transfer. When the fluid chamber is not filled with pressurized fluid, the coupling ring transfers no torque anymore, because the lateral contact surface of the coupling ring can rotate relative to the lateral surface of the first shaft due to no or reduced friction forces.

The coupling ring comprises furthermore a shear tube closing the pressurized fluid chamber to hold the pressure, whereby the shear plate is designed to cut off a tip of the shear tube in order to open the pressure fluid chamber if the first shaft is slipping relatively to the coupling ring, which is the case, when the torque is higher than a predefined maximum transferable torque given by the fluid pressure and the design of the coupling. By cutting off the tip of the shear tube the pressure fluid chamber is opened and the fluid pressure is relieved. Thereby the surface pressure between the lateral surface of the coupling ring and the first shaft is reduced and no torque is transferred. With this configuration the drive train is protected against overload for example in case of blocking on the load side of the drive train or in case of too high torque.

After refilling the pressure fluid chamber with pressurized fluid and closing the opening, for example with a new shear tube, the coupling is reset and again transfers torque between first shaft and coupling ring.

Such torque limiting couplings are known in prior art for example disclosed in U.S. Pat. No. 4,264,229, as shown in the embodiment according to FIG. 5. Those couplings are often used as safety couplings to protect a drive train from overload. That is especially important for drive trains where a blockage could occur at the load side.

Those couplings comprise a coupling ring and the thickness of the coupling ring can be increased by a pressurized fluid chamber within that ring. So sufficient contact pressure is created for transferring torque. Once the fluid pressure is relieved, the contact pressure and with that the friction forces are low, torque transfer is no longer possible. The shaft and the coupling ring rotate relative to each other.

The torque limiting couplings need to provide a high reliability, should take not too much space for installation and should be easily refillable after release of the coupling. These are in many applications diverging demands. The correct assembly is very difficult and critical regarding functionality. It needs to become easier and less sensitive to failures.

### SUMMARY OF THE INVENTION

It is accordingly an object of the invention to provide a torque limiter coupling which overcomes a variety of disadvantages of the heretofore-known devices and methods of this general type and which provides for an improvement of the torque limiting coupling by saving space for installation, increasing reliability and allowing easier assembly, as well as a reduction of costs.

With the above and other objects in view there is provided, in accordance with the invention, a torque limiting coupling, comprising:

a shaft (hereinafter first shaft) formed with a conical connector;

a coupling ring arranged coaxially with said first shaft, said coupling ring having a lateral surface in contact with a lateral surface of said first shaft;

said coupling ring having a double-walled section with an internal annular pressure fluid chamber, configured to increase a radial thickness of said section when said fluid chamber is filled with pressurized fluid and to thereby increase pressure forces and friction forces between the lateral surface of said coupling ring and the lateral surface of said first shaft in order to enable a torque transfer, and wherein said coupling ring transfers substantially no torque, when said fluid chamber is not filled with pressurized fluid;

said coupling ring having a shear tube configured to close said pressure fluid chamber to hold pressure in said pressure fluid chamber;

a shear plate and a central bolt fixedly connecting said shear plate to said first shaft;

said shear plate being configured to cut off a tip of said shear tube in order to open said pressure fluid chamber when said first shaft slips relatively to said coupling ring when the torque is higher than a predefined maximum transferable torque given by the pressure in said pressure fluid chamber and a design of the torque limiting coupling; and

a conical bushing connected to, or forming part of, said shear plate, and wherein said shear plate is fixed to said first shaft by said central bolt pressing said conical bushing against said conical connector of said first shaft.

In other words, the novel torque limiting coupling according to the invention is characterized in that the first shaft comprises a conical connector and that the shear plate is fixed by one central bolt to the first shaft. The shaft presses a conical bushing, which is connected to or which is part of the shear plate, against the conical connector. With this novel design the installation and the refilling after release become easier while the coupling is very reliable. Also, the novel torque limiting coupling is greatly advantageous in terms of its disassembly, as compared to the prior art designs.

One advantage is that the shear plate is reliably connected to the first shaft with low space demand for installation. The conical connector and the appropriate conical bushing of the shear plate provides a high friction force between the first shaft and the shear plate even at a quite low tightening torque of the bolt. That allows to use a smaller bolt, which on one hand saves space for the components and on the other hand gives the possibility to use smaller tools for assembly. In many cases not only space for the components itself is limited but also space for handling the tools during assembly. Furthermore the assembly is easier and faster.

A further advantage of this solution is the better access for refilling after release of the coupling. After the release of the coupling the shear tube is cut off and needs to be replaced. In many cases the shear plate blocks access to the bore of the shear tube. With the inventive design the shear plate is fixed to the first shaft by only one central bolt for fastening. That allows always to bring a recess of the shear plate over the position of the shear tube just by loosen the bolt and rotating only the shear plate independently to the first shaft. After replacing the shear tube the shear plate can be fixed in any angular position. So the refilling and the reset of the coupling can happen with minimum effort.

For access to the shear tube it is not necessary to remove the whole shear plate and to reinstall it again or to rotate the first shaft relatively to the coupling ring to get access. As it would be necessary, if more bolts are used to mount the shear plate. Both of these options cause trouble in a still-standing drive train and makes the refilling more complicated.

Also for other maintenance work it is advantageous to have with the new design an easier way for disassembly and re-assembly.

Explicitly mentioned is that according to the invention as claimed the conical connection between first shaft and shear plate can be a conical connector like a pin at the first shaft and a conical bushing with an appropriate cavity. Or vice versa with a conical bushing forming a conical pin and a conical connector formed as an appropriate conical cavity in the first shaft.

A preferred pressure fluid for the coupling is oil or any other fluid suitable for this function.

In a preferred embodiment the shear plate comprises at least two recesses each with a shear edge suitable to cut off the shear tube. An improved balancing is achieved with two recesses in opposite position.

In a further preferred embodiment the shear plate comprises at least one recess, especially preferred at least two recesses, giving an open area with an opening angle β with reference to the axis of at least 20°, preferred of at least 40°. With such an enlarged recess the access to the coupling ring is further improved, especially for access to the shear tube and simultaneously to the pressure fluid port. By using at least two such enlarged recesses, especially in opposite position, the balancing is improved.

Additionally to the recesses with shear edge, it can be advantageous to have at least two further recesses to give also simultaneously access to a further port or screw, for example to a lubrication oil port. So a full dismounting of the shear plate can be avoided, even if lubrication oil is changed after a release of the coupling.

Furthermore, it is advantageous for the torque limiting coupling if the conical connector has an angle of the taper α of more than 6°, preferred of more than 12°. With such a lower limit for the angle α it is avoidable that the conical connection becomes self-retaining. Depending on the friction coefficient, which is for steel-steel contact normally in the range between 0.1 and 0.2, the limit for self-retaining is region of 5° or up to 11°.

By avoiding self-retaining the disassembly easier and the shear plate is rotatable with low effort for getting better access to the coupling ring.

In another preferred embodiment has the conical connector an angle of the taper α of less than 35°, preferred of less than 25°. With such an upper limit for the angle α the pressing effect in the conical connection can be optimized. The required strength for the connection can be reached even with lower bolt preload, so that a smaller bolt and a moderate tightening torque can be used.

It is an advantage if the conical connector and the shear plate are made in one piece. By this the handling of the shear plate is easier and the assembly and the rotation of the shear plate is possible with minimum effort. Especially in confined spaces in a drive train this is preferred.

With the above and other objects in view there is provided, in accordance with the invention, a further preferred embodiment of a torque limiting coupling, which additionally comprises a second shaft which is connected to the coupling ring, where the coupling ring comprises a coupling sleeve which is arranged in radial direction (R) between the first shaft and the second shaft, and where the coupling sleeve is the double-walled section with the internal annular pressure fluid chamber. In this embodiment the coupling sleeve transfers the torque between the lateral surfaces of the first shaft and the second shaft. The second shaft is preferred formed by a hollow shaft. The advantage is that the coupling ring is a separate component. The first and the second shaft can be part of the drive side or the load side of the drive train.

In a further preferred embodiment for the coupling the length L of the coupling sleeve is between 50 mm and 250 mm, preferred between 80 mm and 180 mm. With that length there is on the one hand enough contact area for the torque transfer and on the other hand enough length for adjustment of the position of the second shaft. As the length L is considered the length of the outer surface in longitudinal direction where the coupling sleeve is in contact with the second shaft.

In order to create enough contact pressure by changing the thickness of the coupling sleeve it is advantageous that the thickness t of the coupling sleeve is between 10 mm and 30 mm. This results in enough stability and enough flexibility of the sleeve to create the necessary surface pressure. Decisive for the transferrable torque are the mechanical properties, such as diameter, length and thickness of the coupling sleeve as well as the fluid pressure.

Further, it is advantageous that the coupling comprises a first roller bearing between the first shaft and the second shaft or between the first shaft and the coupling ring, and that it comprises a second roller bearing between the first shaft and the coupling ring. With these roller bearings the second shaft can rotate around the first shaft with reduced friction, when the pressure fluid chamber is not filled with pressurized fluid. That reduces the risk of damages for the contact surfaces.

In an especially preferred embodiment the second shaft is a hollow shaft of a rotor of an electric motor. Due to the improved possibilities for adjustment of the second shaft it is possible to directly include the hollow shaft of a rotor in the torque limiting coupling.

Furthermore, it is possible that the first shaft is formed by the driven shaft of an electric motor to be connected to a load or a gear.

That feature allows an integration of the torque limiting coupling in an electric motor and saves installation space in applications.

In a preferred application, the torque limiting coupling is designed to be used in the main drive train of a tunnel boring machine, especially in an electric motor of the main drive. Particularly in tunnel boring machines it is important that the drive train be reliably protected against overload. But it is also necessary to save space for installation and to simplify the assembly.

Other features which are considered as characteristic for the invention are set forth in the appended claims.

Although the invention is illustrated and described herein as embodied in a torque limiting coupling, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic view of an embodiment according to the invention;

FIG. 2A is a front end view of an embodiment according to the invention;

FIG. 2B is a longitudinal section taken along the line A-A in FIG. 2A;

FIG. 3A is a longitudinal section of a further embodiment of a torque limiting coupling with a coupling sleeve; and

FIG. 3B is an end view thereof defined by the line B-B in FIG. 3A and viewed in the direction of the arrows.

In the following description of the figures, the same reference numerals refer to the same or similar parts or components.

### DETAILED DESCRIPTION OF THE INVENTION

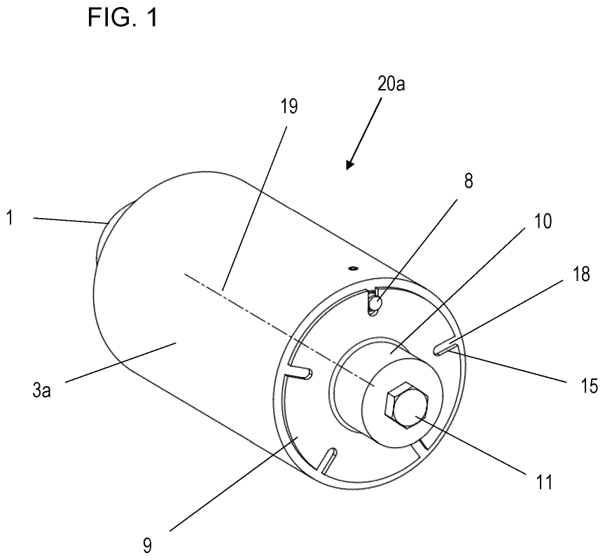

Referring now to the figures of the drawing in detail and first, in particular, to FIG. 1 thereof, there is shown a preferred embodiment according to the invention. The torque limiting coupling 20a comprises a first shaft 1, a coupling ring 3a and a shear plate 9 tightly connected to the first shaft 1 with a central bolt 11. The coupling ring 3a is positioned concentric to the first shaft 1 with its axis 19.

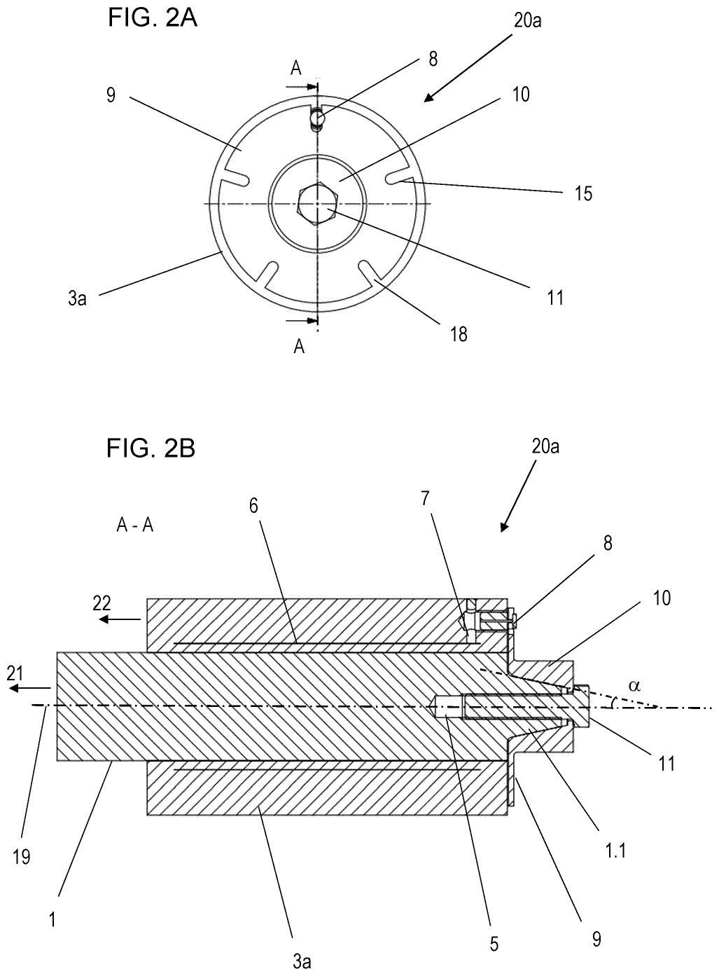

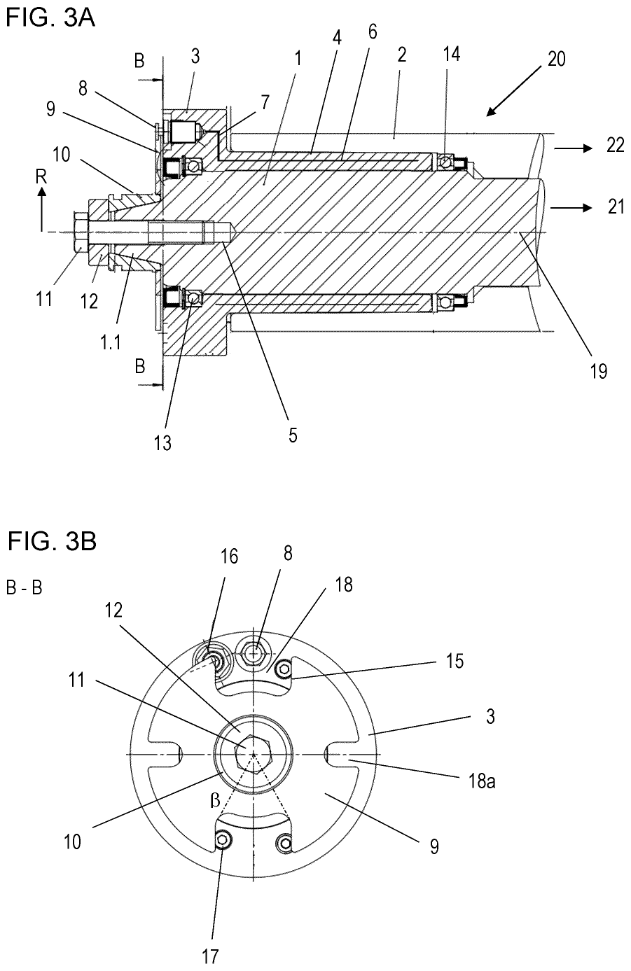

The central bolt 11 presses a conical bushing 10 onto the conical connector 1.1 (cf. FIGS. 2B, 3A) of the first shaft 1. The shear plate 9 is formed with several recesses 18 each with a shear edge 15. In case of a torque that is too high, higher than the maximum limit for the transferable torque, the first shaft 1 slips relatively to the coupling ring 3a. Thus, the shear plate 9 tightly connected to the first shaft 1 cuts off the tip of the shear tube 8 by one of the shear edges 15. For balancing purpose there can be several recesses 18 in the shear plate, which are distributed at regular angular spacings over the circumference.

FIG. 2A shows the front view of the torque limiting coupling 20a. For refilling after the release of the coupling the shear tube 8 needs to be replaced by a new one. And therefore, access to the bore of the shear tube 8 is necessary. By loosening the central bolt 11 the shear plate 9 becomes rotatable and can be adjusted in any angular position. After replacing the shear tube 8 the shear plate is fixed by tightening the central bolt 11.

FIG. 2B shows a sectional view along the line A-A. The shaft 1, which is incorporated in a drive train, is connected to a load 21. The coupling ring 3a is connected to a drive or motor 22. In case of a blocking or excess torque, the shear tube 8 is cut off by the shear plate 9. The fluid flows through the pressure fluid channel 7 out of the pressure fluid chamber 6 and thus the contact pressure between first shaft 1 and coupling ring 3a is reduced. No torque transfer takes place anymore. The coupling 20a is released.

The sectional view shows the conical connector 1.1 of the first shaft with the central bore 5 for the bolt 11 and the conical bushing 10 of the shear plate 9. It is preferred for the conical bushing 10 and the shear plate 9 to be made in one piece. Alternatively, they can be made as two parts that are tightly connected. Due to the tightening torque of the central bolt 11 the conical connection 1.1, 10 is pressed together to build up a torque-proof connection between the shear plate 9 and first shaft 1. The transferable torque in that conical connection needs to be significantly higher than the transferable torque in the coupling and high enough to cut off the shear tube 8 reliably.

The preferred upper limit of the cone angle α less than 35°, especially less than 25°. This upper limit is set in order to reach a higher pressure at a low tightening torque and thus with a smaller bolt. That allows easier assembly and smaller tools for installation.

On the opposite, the preferred lower limit for the cone angle α is at least 6°, especially at least 12°. Thereby, it is avoided that the conical connection becomes self-retaining. Self-retention would lead to problems with disassembly and would complicate loosening of the shear plate 9 for rotating them to get access to the shear tube 8 for replacing.

Alternatively to the illustrated embodiment, the inventive solution can also be realized with a conical connection where the conical bushing is forming a conical pin and the conical connector is formed as an appropriate conical cavity in the first shaft.

FIGS. 3A and 3B show a preferred embodiment for a torque limiting coupling 20 according to the invention with the first shaft 1 and a second shaft 2 and the coupling ring 3 as a separate component. The first shaft 1 is connected, or formed for connection, to a load 21. The coupling ring 3 is mounted on the cylindrical surface of the first shaft 1. The coupling ring 3 comprises a connection flange and the coupling sleeve 4. The coupling sleeve 4 is positioned in radial direction R between the first shaft 1 and the second shaft 2. The second shaft 2 is designed as hollow shaft or a hub. It is connected or to be connected to a drive 22, for example to the rotor of an electric motor.

The coupling sleeve 4 has an inner surface, which is in contact with the cylindrical surface of the first shaft 1, and an outer surface, which is in areal contact with the second shaft 2. The coupling sleeve 4 includes the pressure fluid chamber 6, which is designed as a narrow annular gap. If this pressure fluid chamber 6 is filled with pressurized fluid the thickness of the sleeve 4 increases and creates the desired contact pressure for the torque transmission between the first shaft 1, the coupling ring 3 and the second shaft 2. If the fluid pressure is relieved there is no torque transmission and the coupling ring 3 slips at the inner surface relatively to the first shaft 1. The torque limiting coupling is released by relieving the fluid pressure.

The shear tube 8 closes the pressure fluid channel 7 and the pressure fluid chamber 6 to maintain the fluid pressure and with it the contact pressure and the ability to transfer torque. The shear tube has a dedicated tip with a breaking point. If the tip is cut off, the pressure fluid channel 7 is open to the ambient surroundings, the fluid pressure is relieved and no torque will be transferred over the coupling ring 3.

For a reliable rotation in case of release of the coupling there are two roller bearings 13, 14 to stabilize the two shafts 1, 2. The first roller bearing 14 between the first shaft 1 and the second shaft 2, and the second roller bearing 13 between the first shaft 1 and the coupling ring 3. Alternatively, the first roller bearing 14 could be also be positioned between the first shaft 1 and the coupling ring 3. Preferably, one or both of the roller bearings 13, 14 are designed as ball bearings. Alternatively the roller bearings can be designed for example as needle bearings or conical roller bearings or as any other type of roller bearings.

Once again, it is shown that the shear ring 9 is connected to the first shaft 1 by one central bolt 11. The first shaft 1 comprises a conical connector 1.1 formed like a pin and the shear plate 9 comprises a conical bushing 10. The distance ring 12 allows a uniform force application into the bushing 10 and for the bolt 11.

FIG. 3A illustrates a sectional view of the torque limiting coupling 20 along the axis 19. FIG. 3B shows the front view along the line B-B. The mounted shear ring 9 is connected to the first shaft by one central bolt 11. The shear ring 9 is formed with several recesses 18 each with a shear edge 15 and is dedicated to release the coupling in case of excessively high torque. If the torque is higher than the maximum transferable torque of the coupling ring 3, the second shaft 2 and the coupling ring 3 slips at the inner surface relatively to the first shaft 1 and the connected shear ring 9. This leads to the shear edge 15 of the shear ring 9 cutting off the tip of the shear tube 8 and the fluid pressure to be relieved. In the shown example the shear plate 9 comprises two recesses 18 with enlarged open area with an opening angle β. The opening angle β is especially at least 20°, or preferred at least 40° to give better access to the coupling ring 3 for maintenance or refilling. Especially to give simultaneously access to the pressure fluid port 16 and the shear tube 8. The further recesses 18a are advantageous to give also simultaneously access to further ports or screws, such as, for example, lubrication oil ports. The opposite position of the two recesses 18 and the two recesses 18a are for improved balancing of the shear plate 9.

When the torque exceeds, or overshoots, the maximum limit the coupling can transfer, the first shaft 1 slips relatively to the coupling ring 3 connected with the second shaft 2. The shear ring 9 rotates relatively to the coupling ring 3 and cuts off the tip of the shear tube 8 and due to this the coupling is released. A replacement of the shear tube 8 and a refill of the pressure fluid chamber with pressurized fluid via the pressure fluid port 16 is required after the release.

Fastening screws or bolts 17 screw the coupling ring 3 to the second shaft 2. Especially preferred is a set of four screws 17, designed in such a way, that the position of the second shaft 2 on the coupling sleeve 4 can be adjusted by the fastening screws 17. The adjustment essentially takes place in longitudinal direction to adapt to any manufacturing or assembly tolerances. By tightening these screws 17 the second shaft 2 is moved over the coupling sleeve 4. The connection between the lateral surfaces of coupling sleeve 4 and second shaft 2 can be a tapered connection or a crimp connection.

The following is a summary list of reference numerals and the corresponding structure used in the above description of the invention:

1 first shaft
1.1 conical connector
2 second shaft
3, 3a coupling ring
4 coupling sleeve
5 central bore
6 pressure fluid chamber
7 pressure fluid channel
8 shear tube
9 shear ring
10 conical bushing
11 central bolt
12 distance ring
13 second rolling bearing
14 first rolling bearing
15 shear edge
16 pressure fluid port
17 fastening screws
18 recess
18a further recess
19 axis
20, 20a torque limiting coupling
21 to load
α angle of the taper
β opening angle of the recess
R radial direction

1. A torque limiting coupling, comprising:
a shaft formed with a conical connector;
a coupling ring arranged coaxially with said shaft, said coupling ring having a lateral surface in contact with a lateral surface of said shaft;
said coupling ring having a double-walled section with an internal annular pressure fluid chamber, configured to increase a radial thickness of said section when said fluid chamber is filled with pressurized fluid and to thereby increase pressure forces and friction forces between the lateral surface of said coupling ring and the lateral surface of said shaft in order to enable a torque transfer, and wherein said coupling ring transfers substantially no torque, when said fluid chamber is not filled with pressurized fluid;
said coupling ring having a shear tube configured to close said pressure fluid chamber to hold pressure in said pressure fluid chamber;
a shear plate and a central bolt fixedly connecting said shear plate to said shaft;
said shear plate being configured to cut off a tip of said shear tube in order to open said pressure fluid chamber when said shaft slips relatively to said coupling ring when the torque is higher than a predefined maximum transferable torque given by the pressure in said pressure fluid chamber and a design of the torque limiting coupling; and
a conical bushing connected to, or forming part of, said shear plate, and wherein said shear plate is fixed to said shaft by said central bolt pressing said conical bushing against said conical connector of said shaft.

2. The torque limiting coupling according to claim 1, wherein said shear plate is formed with at least two recesses each having a shear edge configured to cut off said shear tube.

3. The torque limiting coupling according to claim 2, wherein said recesses are arranged radially opposite one another on the shear plate.

4. The torque limiting coupling according to claim 1, wherein said shear plate is formed with at least one recess providing an open area with an opening angle β, relative to an axis of said shaft, of at least 20°.

5. The torque limiting coupling according to claim 4, wherein the opening angle β is at least 40°.

6. The torque limiting coupling according to claim 1, wherein said conical connector has an angle of taper α of more than 6°.

7. The torque limiting coupling according to claim 6, wherein said angle of taper α of more than 12°.

8. The torque limiting coupling according to claim 1, wherein said conical connector has an angle of the taper α of less than 35°.

9. The torque limiting coupling according to claim 8, wherein said angle of the taper α of less than 25°.

10. The torque limiting coupling according to claim 1, wherein said conical bushing and said shear plate are made in one piece.

11. The torque limiting coupling according to claim 1, wherein said shaft is a first shaft and the torque limiting coupling further comprises a second shaft connected to said coupling ring;
said coupling ring having a coupling sleeve disposed in a radial direction between said first shaft and said second shaft; and
said coupling sleeve forming said double-walled section with said internal annular pressure fluid chamber.

12. The torque limiting coupling according to claim 11, wherein a length L of said coupling sleeve is between 50 mm and 250 mm.

13. The torque limiting coupling according to claim 11, wherein the length L of said coupling sleeve is between 80 mm and 180 mm.

14. The torque limiting coupling according to claim 11, wherein a thickness of said coupling sleeve in the radial direction R is between 10 mm and 30 mm.

15. The torque limiting coupling according to claim 11, further comprising a first roller bearing between said first shaft and said second shaft or between said first shaft and said coupling ring, and a second roller bearing between said first shaft and said coupling ring.

16. The torque limiting coupling according to claim 11, wherein said second shaft is a hollow shaft of a rotor of an electric motor.

17. The torque limiting coupling according to claim 1, wherein said first shaft is a driven shaft of an electric motor to be connected to a load or a gear.

18. The torque limiting coupling according to claim 1, configured for use in a main drive train of a tunnel boring machine.
